(19) United States
(12) Patent Application Publication
(10) Pub. No.: US 2008/0042090 A1
(43) Pub. Date: Feb. 21, 2008

(54) Piloted solenoid valve assemblies and related methods

(75) Inventor: Michael J. Zweber, New Prague, MN (US)

Correspondence Address: SCHWEGMAN, LUNDBERG & WOESSNER, P.A., P.O. BOX 2938, MINNEAPOLIS, MN, 55402, US

(73) Assignee: Restaurant Technologies, Inc., eagan, MN (US)

(21) Appl. No.: 11/893,971

(22) Filed: Aug. 17, 2007

Related U.S. Application Data
(60) Provisional application No. 60/838,675, filed on Aug. 18, 2006.

(51) Int. Cl. F16K 31/02

(52) U.S. Cl. 251/129.15

(57) ABSTRACT

This patent document describes various valve assemblies comprising a valve member movable between an outlet flow-blocking and an outlet flow-passing position. A portion of a valve member first end is covered by a pilot, while a valve member second end is operatively associated with a solenoid mechanism. In an example, the solenoid mechanism is configured to initially move the valve member from the outlet flow-blocking to a bleed position, and subsequently move the valve member from the bleed position to the outlet flow-passing position. The pilot covers the valve member such that a solenoid mechanism force needed to move the valve member from the outlet flow-blocking position is reduced. For instance, the pilot reduces a surface area of the valve member subject to a housing outlet pressure.

### PRIORITY OF INVENTION

This non-provisional patent application claims the benefit of priority under 35U.S.C. § 119(e) to U.S. Provisional Patent Application Ser. No. 60/838,675, filed on Aug. 18, 2006, which is herein incorporated by reference in its entirety.

### TECHNICAL FIELD

This patent document pertains generally to valve assemblies for a fluid handling system. More particularly, but not by way of limitation, this patent document pertains to piloted solenoid valve assemblies and related methods providing flow control through one or more portions of a fluid handling system.

### BACKGROUND

Solenoid valve assemblies are control units which are typically used wherever fluid flow has to be controlled automatically. These control units, when electrically energized or de-energized, either block or allow fluid flow through a passage of a fluid handling system. When energized, a magnetic field builds up in and around a coil of the control unit which pulls or pivots a valve member disposed within a valve housing against the action of a spring to an open position. When de-energized, the valve member is returned to its original closed position by the spring action.

The valve housing typically includes a plurality of fluid passages that are selectively interconnected in response to movement of the valve member so-as-to control the flow of fluid, and thus, the outlet of the solenoid valve assemblies.

### OVERVIEW

The present inventor has recognized, among other things, that one problem presented by conventional solenoid valve assemblies is that housing outlet pressures, such as vacuum pressures, act on substantially an entire leading surface of the assemblies' valve member. Because these pressures are allowed to act over such a relative large surface area, a housing outlet force felt by the valve member may be greater than any opposing opening force a solenoid mechanism is able to generate and apply to the valve member, thus making portions of a fluid handling system locked and inoperable. The present inventor has further recognized that there exists an unmet need for valve assemblies including a pilot covering a portion of a valve member first end, thereby reducing the solenoid mechanism force needed to move the valve member from an outlet flow-blocking position without reducing the effective diameter of the housing outlet.

This patent document describes various valve assemblies comprising a valve member movable between an outlet flow-blocking and an outlet flow-passing position. A portion of a valve member first end is covered by a pilot, while a valve member second end is operatively associated with a solenoid mechanism. In an example, the solenoid mechanism is configured to initially move the valve member from the outlet flow-blocking to a bleed position, and subsequently move the valve member from the bleed position to the outlet flow-passing position. The pilot covers the valve member such that a solenoid mechanism force needed to move the valve member from the outlet flow-blocking position is reduced. For instance, the pilot reduces a surface area of the valve member subject to one or more housing outlet pressures in opposition to the opening solenoid mechanism force.

In Example 1, a valve assembly comprises a valve member extending from a valve first end to a valve second end, the valve member movable between an outlet flow-blocking and an outlet flow-passing position; a solenoid mechanism operatively associated with the valve second end to move the valve member from the outlet flow-blocking to the outlet flow-passing position; and a pilot covering a portion of the valve first end, the pilot reducing a solenoid mechanism force needed to move the valve member from the outlet flow-blocking position.

In Example 2, the valve assembly of Example 1 optionally comprises a resilient member configured to bias the valve member in opposition to a movement caused by the solenoid mechanism.

In Example 3, the valve assembly of at least one of Examples 1-2 optionally comprises a housing having at least one housing inlet, at least one housing outlet, and a housing bore therebetween, the housing bore including at least the valve first end disposed therein.

In Example 4, the valve assembly of Example 3 is optionally configured such that the housing includes a housing by-pass, the housing bore in fluid communication with the housing by-pass.

In Example 5, the valve assembly of at least one of Examples 3-4 is optionally configured such that a pilot seat surrounds the housing outlet, a portion of the pilot contacting the pilot seat at least when the valve member is in the outlet flow-blocking position.

In Example 6, the valve assembly of at least one of Examples 1-5 is optionally configured such that the pilot includes a pilot inlet, a pilot outlet, and a pilot bore therebetween, the valve first end disposed in the pilot bore such that a portion thereof faces the pilot outlet.

In Example 7, the valve assembly of Example 6 is optionally configured such that the valve first end is movable within the pilot bore between a bleed and a non-bleed position, the non-bleed position defined by the valve first end contacting a valve member seat surrounding the pilot outlet.

In Example 8, the valve assembly of Example 7 is optionally configured such that the valve first end is spaced from the valve member seat in the bleed position.

In Example 9, the valve assembly of at least one of Examples 7-8 is optionally such that the pilot reduces a surface area of the valve first end subject to a pressure extending through the housing outlet when the valve first end is in the non-bleed position.

In Example 10, a valve assembly comprises a housing including a housing inlet, a housing outlet, and a housing bore, the housing bore connecting at least the housing inlet and housing outlet; a valve member including a head region disposed within the housing bore, the valve member movable between an outlet flow-blocking and an outlet flow-passing position; a solenoid mechanism operatively associated with the valve member to move the valve member from the outlet flow-blocking to the outlet flow-passing position; and a pilot covering at least a portion of the head region such that a reduced surface area of the head region is in communication with a pressure extending through the housing outlet when the valve member is in the outlet flow-blocking position.

In Example 11, the valve assembly of Example 10 optionally comprises a resilient member configured to bias the valve member in opposition to a movement caused by the solenoid mechanism.

In Example 12, the valve assembly of at least one of Examples 10-11 is optionally configured such that the pilot includes a pilot inlet, a pilot outlet, and a pilot bore therein, the head region disposed in the pilot bore such that the reduced surface area aligns with the pilot outlet.

In Example 13, the valve assembly of Example 12 is optionally configured such that the head region is movable between a non-bleed position in which a perimeter of the reduced surface area contacts a valve member seat surrounding the pilot outlet and a bleed position in which the perimeter of the reduced surface area is spaced from the valve member seat.

In Example 14, the valve assembly of Example 13 is optionally configured such that the head region of the valve member is movable relative to the pilot between the non-bleed and bleed positions.

In Example 15, a method comprises reducing a housing outlet pressure acting on a valve first end of a valve member, including coving a portion of the valve first end with a pilot; operating a solenoid mechanism to move the valve member toward a bleed position in opposition to a spring bias; and bleeding the housing outlet pressure, including allowing fluid flow into and through the pilot.

In Example 16, the method of Example 15 optionally comprises operating the solenoid mechanism to move the valve member from the bleed position toward an outlet flow-passing position in further opposition to the spring bias.

In Example 17, the method of Example 16 optionally comprises flowing fluid into a housing inlet and out a housing outlet.

In Example 18, the method of at least one of Examples 15-17 optionally comprises biasing the valve member to move toward an outlet flow-blocking position, including allowing fluid to flow out a housing by-pass.

In Example 19, the method of at least one of Examples 15-18 is optionally configured such that coving the portion of the valve first end with the pilot includes reducing a surface area of the valve first end subject to the housing outlet pressure when the valve member is in an outlet flow-blocking position.

In Example 20, the method of at least one of Examples 15-19 is optionally configured such that moving the valve member toward the bleed position includes moving the valve member relative to the pilot.

In Example 21, the method of at least one of Examples 15-20 is optionally configured such that moving the valve member toward the bleed position includes moving the valve member within a pilot bore to a position spaced from a pilot outlet.

In Example 22, the method of at least one of Examples 15-21 is optionally configured such that moving the valve member toward the bleed position includes generating a solenoid mechanism force greater than the reduced housing outlet pressure acting on the valve first end.

Advantageously, the present valve assemblies and methods can provide for a reduction or avoidance of vacuum or other jamming effects within a fluid handling system via enhanced valve member opening construction. This enhanced valve member opening construction can be relatively low in cost to manufacture and compact in size. In addition, the present valve assemblies can be retrofitted within the design constraints of an already existing fluid handling system by being amenable to compact and large constructions, depending on the system's need(s). This retrofitability avoids the expense of realigning fluid lines to accommodate new valve assembly housings of different or increased dimensions. These and other examples, advantages, and features of the present assemblies and methods will be set forth in part in the following Detailed Description. This Overview is intended to provide an overview of subject matter of the present patent document. It is not intended to provide an exclusive or exhaustive explanation of the invention. The Detailed Description is included to provide further information about the present patent document.

### BRIEF DESCRIPTION OF THE DRAWINGS

In the drawings, like numerals describe similar components throughout the several views. Like numerals having different letter suffixes represent different instances of similar components. The drawings illustrate generally, by way of example, but not by way of limitation, various embodiments discussed in the present document.

FIG. 1 is an isometric view of a piloted solenoid valve assembly and an environment in which the valve assembly can be used, the valve assembly including a pilot reducing a solenoid mechanism force needed to move a valve member from an outlet flow-passing position.

FIG. 2 is a cross-sectional view of a piloted solenoid valve assembly, such as along line 2-2 of FIG. 1, the valve assembly including a valve member in a non-bleed and outlet flow-blocking position.

FIG. 3 is a cross-sectional view of a piloted solenoid valve assembly in which a valve member is in a bleed position.

FIG. 4 is a cross-sectional view of a piloted solenoid valve assembly in which a valve member is in an outlet flow-passing position.

FIG. 5 is a schematic view of one or more stations, fluid lines, and valves of a fluid handling system configured for the storing and distributing of fresh oil, the filtering and recirculation of used oil, and the storing and elimination from the system of waste oil.

FIG. 6 is a schematic view of portions of the fluid handling system illustrated in FIG. 5, including a fryer/filter pump and system components associated therewith.

FIG. 7 is a block diagram of an example method of using a piloted solenoid valve assembly, the valve assembly including a pilot reducing a solenoid mechanism force needed to move a valve member from an outlet flow-blocking position.

### DETAILED DESCRIPTION

Valve assemblies for fluid handling systems are provided. The valve assemblies include a valve member having a first end movable between an outlet flow-passing and an outlet flow-blocking position. The valve assemblies include a solenoid mechanism operatively associated with a valve member second end to move the valve first end toward the outlet flow-passing position. Advantageously, the present valve assemblies further include a pilot configured to cover a portion of the valve first end which would otherwise be subject to housing outlet pressures, thereby potentially reducing a solenoid mechanism force needed to move the valve member from the outlet flow-blocking position. In this way, the pilot allows the valve assemblies to overcome greater vacuum and other housing outlet pressures opposing valve member movement from the outlet flow-blocking position than what are possible using conventional solenoid valve assemblies.

### EXAMPLES

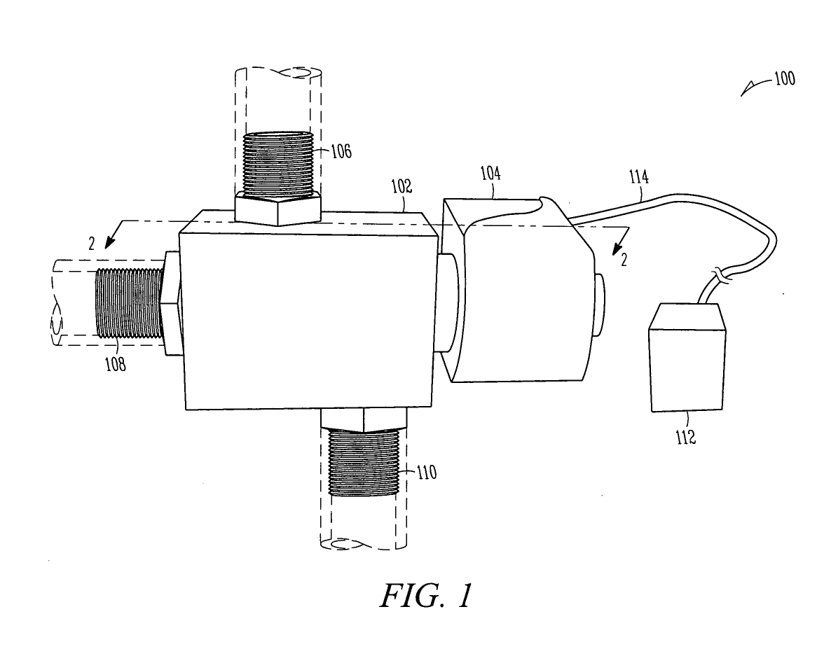

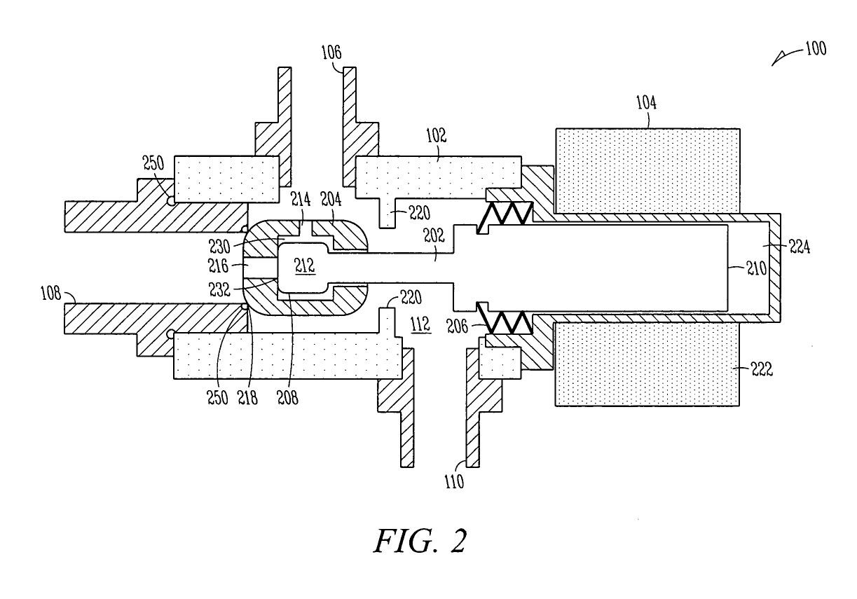

FIG. 1 is an isometric view of a piloted solenoid valve assembly 100 and an environment in which the valve assembly can be used. The valve assembly 100 includes, among other things, a housing 102, a valve member 202 (FIG. 2) disposed within the housing, a pilot 204 (FIG. 2) covering a portion of the valve member, and a solenoid mechanism 104. The valve assembly 100 can be used with liquids, gases, or other fluids and controlled by running or stopping an electrical current through the solenoid mechanism 104, thereby changing a positional state of the valve member 202 within the housing 102. In the example shown, the housing 102 includes a housing inlet 106, a housing outlet 108, and a housing by-pass 110. By changing the positional state of the valve member 202, fluid flow though the valve assembly 100 can be switched between the housing outlet 108 and the housing by-pass 110.

In operation, an electrical signal from a controller 112 can be received by the solenoid mechanism 104 via a communication line 114. Upon receipt, the solenoid mechanism 104 converts the electrical signal into mechanical energy by attracting a second end of the valve member 202 causing a valve first end to move. Based on relative positioning of the valve member 202 within the housing 102, one or both of the housing outlet 108 or the housing by-pass 110 can remain open regardless of the valve member position. In an example, the electrical signal from the controller 112 causing the solenoid mechanism to attract the valve member 202 is generated in response to operator input. In another example, the electrical signal from the controller 112 is generated in response to one or more sense signals received from a fluid handling system sensor. Because movement of the valve member 202 can be affected electronically, fluid flow through the valve assembly 100 can advantageously be precisely controlled.

FIG. 2 is a cross-sectional view of a piloted solenoid valve assembly 100, such as along line 2-2 of FIG. 1. As shown in this cross-sectional view, the valve assembly 100 can include a housing 102, a valve member 202, a solenoid mechanism 104, and a pilot 204. Optionally, the valve assembly 100 can further include a resilient member 206, such as a spring, to hold the valve member 202 in an outlet flow-blocking position when the solenoid mechanism 104 is de-activated. Further yet, the valve assembly can include one or more valve seals 250, such as o-ring seals composed of EDPM or PTFE. In this example, the housing 102 includes a housing inlet 106, a housing outlet 108, a housing by-pass 110, and a housing bore 112. The housing bore 112 can longitudinally extend within the housing 102 and can have a generally cylindrical configuration for receiving the valve member 202 and pilot 204 in a sliding manner for axial reciprocable movement of the same. Each of the housing inlet 106, the housing outlet 108, and the housing by-pass 110 can be fluidly connected within this longitudinal central housing bore 112. In an example, at least one of the housing 102 or the valve member 202 is composed, at least in part, of steel or other material resistant to corrosive fluid attack.

The valve member 202 extends from a valve first end 208 to a valve second end 210. In an example, the valve first end 208 includes a head region 212. The pilot 204 covers a portion of the valve first end 208, such as the head region 212. In an example, the pilot 204 includes a pilot inlet 214, a pilot outlet 216, and pilot bore 230 therewithin. The valve first end 208 can be disposed in the pilot bore 230 such that a portion thereof aligns with the pilot outlet 216. The valve first end 208 is movable within the pilot bore 230 between a non-bleed position in which the valve first end contacts a valve member seat 232 and a bleed position in which the valve first end is spaced from the valve member seat 232.

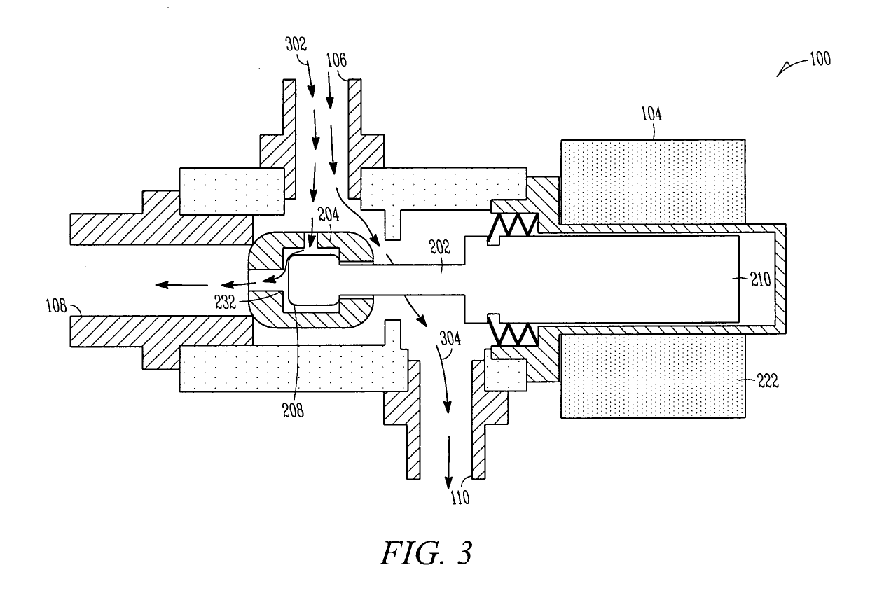

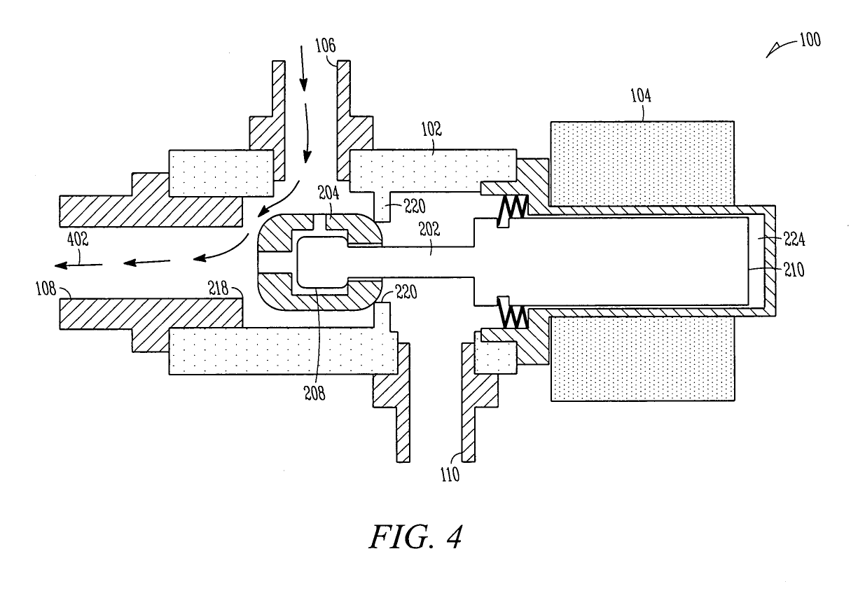

The valve member 202 and covering pilot 204 can be disposed in the housing 102 to provide a three stage operation. In the first stage, as shown in the example of FIG. 2, pressurized fluid can enter the housing inlet 106 and be supplied to the housing by-pass 110 when the valve member 202 is in the outlet flow-blocking and non-bleed positions. At the outlet flow-blocking position, a portion of the pilot 204 facing the housing outlet 108 is seated against a pilot seat 218 on the housing 102. In the second stage, as shown in the example of FIG. 3, pressurized fluid can enter the housing inlet 106 and some of the fluid can be supplied to the housing by-pass 110, while other fluid can be allowed to bleed into the housing outlet 108. In the third stage, as shown in the example of FIG. 4, pressurized fluid can enter the housing inlet 106 and be supplied solely to the housing outlet 108 as the valve member 202 is in the outlet flow-passing position. At the outlet flow-passing position, back-end portions of the pilot 204 can abut internal housing projections 220, thereby precluding fluid flow from entering the housing by-pass 110.

The solenoid mechanism 104 includes an electromagnetic coil 222 wound about a generally cylindrical solenoid bore 224, in an example. The valve second end 210 can include a ferromagnetic material (e.g., steel) and can be partially disposed in the solenoid bore 224. When the solenoid mechanism 104 is activated, the valve second end 210 can be attracted and further received by the solenoid bore 224. Initially, as the solenoid mechanism 104 receives the valve second end 210, the valve first end 208 is caused to move from the non-bleed position to the bleed position, and subsequently, the pilot 204 front-end is caused to move away from the pilot seat 218 when the valve first end reaches the outlet flow-passing position.

The resilient member 206 can be trapped in a cylindrical counterbore between portions of the valve member 202 and the housing 102. In the example shown, the resilient member 206 is positioned and configured to bias the valve member 202 toward the outlet flow-blocking position. It should be appreciated that the resilient member 206 can be eliminated from the valve assembly 100. In such an example, the valve member 202 moves toward the outlet flow-blocking position due to gravity, fluid pressures within the valve assembly 100, or a valve member design having an outlet flow-blocking position preference.

For the valve first end 208 to move away from the outlet flow-blocking position in which portions of the pilot 204 are seated against the pilot seat 218, the solenoid mechanism 104 must generate and apply an opening force to the valve second end 210 greater than an opposing force to which the valve first end is subject to. In example, the valve first end 208 is subject to any opposing pressures in the housing outlet 108 and the force applied by the resilient member 206. By determining the amount of surface area on which the opposing pressures in the housing outlet 108 act on, an opposing outlet force can be calculated and added to the force applied by the resilient member 206 to calculate the magnitude of the overall opposing force which must be overcome for valve member 202 movement. The larger the surface area on which the opposing housing outlet pressures act on, the larger the overall opposing force will be. Advantageously, in the present valve assemblies, the pilot 204 covers surface area portions of the valve first end 208 which would otherwise be subject to the opposing housing outlet pressures. By reducing the surface area subject to the opposing housing outlet pressures, the force opposing the solenoid mechanism opening force can be reduced.

FIG. 3 is a cross-sectional view of a piloted solenoid valve assembly 100 in which a valve member 202 is in a bleed position. As discussed above, electrical current can be supplied to an electromagnetic coil 222 of a solenoid mechanism 104 to create a magnetic field which attracts a second end 210 of the valve member 202. Once a solenoid mechanism generated force is greater than an opposing force acting on a first end 208 of the valve member 202, the valve member can move to the bleed position shown. To reach the bleed position, the valve first end 208 moves from an outlet flow-blocking, non-bleed position to a position spaced from a valve member seat 232 on a pilot 204. The moving of the valve member 202 from the outlet flow-blocking position to the bleed position allows some pressurized fluid to follow a path 302 through a housing inlet 106, the pilot 204, and a housing outlet 108. At the same time, other pressurized fluid entering the housing inlet 106 is allowed to follow a path 304 though a housing by-pass 110.

FIG. 4 is a cross-sectional view of a piloted solenoid valve assembly 100 in which a valve member 202 is in an outlet flow-passing position. Through continued energizing of a solenoid mechanism 104, a second end 210 of the valve member 202 can be further attracted and received by a solenoid bore 224 causing a valve first end 208 to move to the outlet flow-passing position. To reach the outlet flow-passing position, the valve first end 208 moves from the bleed position to a position in which a pilot 204 is urged away from a pilot seat 218 on a housing 102. In the example shown, the pilot 204 has been urged away from the pilot seat 218 to a position in which the pilot back-end is abutted against internal housing projections 220. This abutment precludes fluid flow from entering a housing by-pass 110. The moving of the valve member 202 from the bleed position to the outlet flow-passing position allows pressurized fluid to follow a path 402 though a housing inlet 106 and a housing outlet 108.

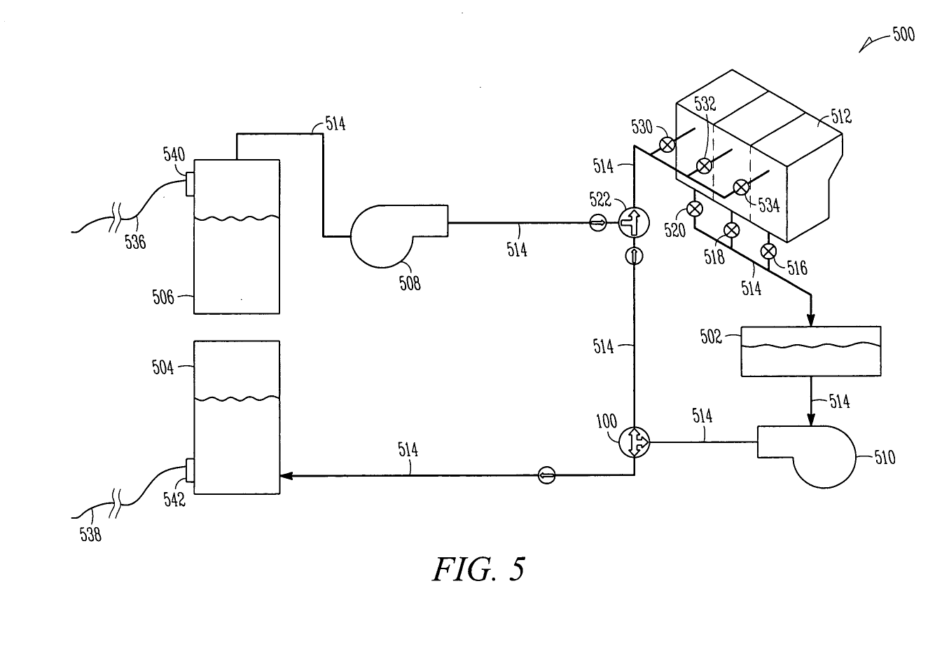

Among other uses, the present piloted solenoid valve assemblies 100 and related methods may find utility in automated cooking oil supply, filter, and disposal systems, such as the oil handing system 500 shown in FIG. 5. As shown, but as may vary, the system 500 comprises a filter station 502, a waste station 504, a supply station 506, a supply pump 508, a fryer/filter pump 510, a fryer station 512, and various valves manually or automatically controllable, such as via a valve panel controller. The stations are interconnected by fluid lines 514 capable of carrying the required flow of cooking oil between selected stations for the various purposes discussed below.

The filter station 502 comprises a filter to separate the cooking oil still amenable to reuse and the residue of carbon and food particles mixed with the used oil from the cooking process. Once filtered, the oil can then be recirculated to the fryer station 512 for reuse. One or more valves, such as drain ball valves 516, 518, 520, are positioned in the fluid lines 514 leading to the entrance of the filter station 502. The drain ball valves 516, 518, 520 can either be manually or electronically operated.

The waste station 504 comprises a waste receptacle to store waste cooking oil which has been degraded beyond appropriate further use in the cooking process. One or more valves including the piloted solenoid valve assembly 100 can be positioned in a fluid line 514 leading to the entrance of the waste station 504. To remove oil from the system 500, a coupling attachment 542 of the waste station 504 is coupled to an outside line 538 leading to a remotely located storage facility, such as a tanker truck for immediate removal.

The supply station 506 comprises a supply storage tank to receive and store fresh cooking oil and provide the same to the fryer station 512 on an as needed basis. The supply pump 512 and one or more valves, such as a check valve assembly 522 including a check member movable to an open position substantially unopposed as discussed in commonly assigned Zweber, U.S. patent application Ser. No. ______, entitled “CHECK VALVE ASSEMBLIES AND RELATED METHODS,” filed even date herewith, are positioned in the fluid lines 514 leading from the exit of the supply station 506 and intersecting with the fluid lines 514 returning to the fryer station 512 from the piloted solenoid valve assembly. 100, as shown. To supply fresh oil to the system 500, an outside line 536 leading to a remotely located source of fresh oil, such as a tank truck or a remotely located storage tank, is coupled to a coupling attachment 540 of the supply station 506.

The supply 508 and fryer/filter 510 pumps function to deliver cooking oil along whatever fluid line path is designed by the appropriate opening and closing of the various system valves. More specifically, the supply pump 508 functions to deliver new oil from the supply station 506 to the fry station 512; whereas the fryer/filter pump 510 functions to either recirculate to the fryer station 512 reusable oil or dispose, via the waste station 504, oil that is beyond appropriate further use.

The fryer station 512 comprises one or more valves, such as return manifold ball valves 530, 532, 534, positioned in the fluid lines 514 leading to the entrance of the fryer station 512. The function of the fryer station 512 is to allow the proper metering of fresh or recycled filtered oil into one or more fryer vats of the fryer station 512.

In brief, the system 500 is designed to operate in close synchronization with the needs of a cooking equipment operator. These needs can vary from the introduction of fresh cooking oil into the system 500 and metering of such oil into the frying station 512, to the recycling/filtering of used cooking oil, and finally, to the complete removal of waste oil from the system 500. Cooking oil systems, such as oil handling system 500, are becoming quite common in fast food and other restaurants, which typically use large quantities of grease or cooking oil in frying during the preparation of food. These automated cooking oil systems advantageously eliminate operator handling of new and used oil and the many problems that are associated therewith. Unfortunately, in the absence of present piloted solenoid valve assembly 100, the oil handling system 500 may become inoperable due to valve lock-up, as discussed below.

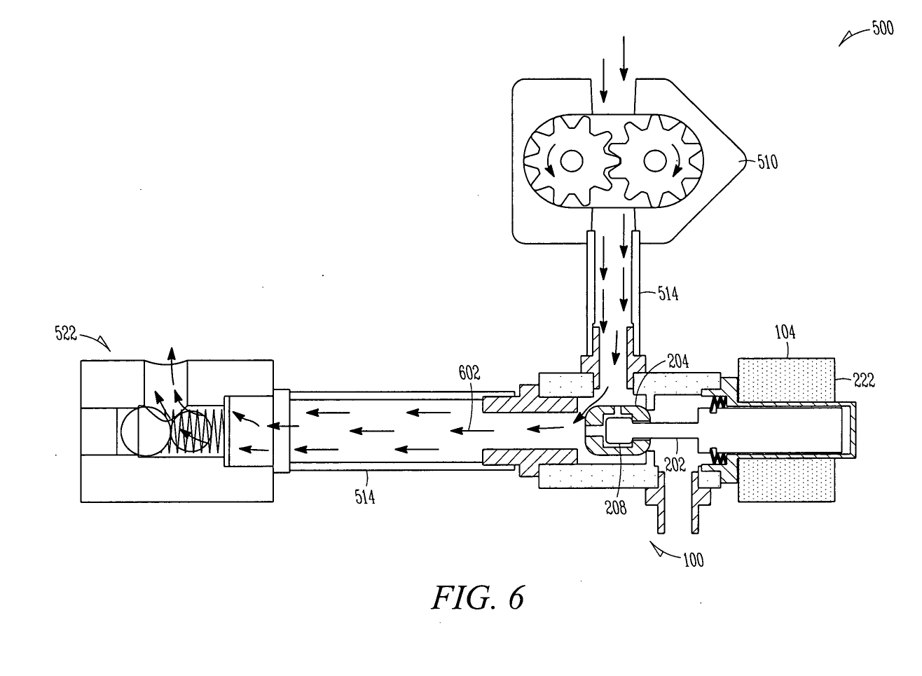

FIG. 6 illustrates portions of the fluid handling system 500 of FIG. 5. More specifically, FIG. 6 illustrates a fryer/filter pump 510, a piloted solenoid valve assembly 100, a check valve assembly 522, and associated fluid lines 514. When it is desired to place fresh oil in the fryer station 512 (FIG. 5), one or more drain ball valves 516, 518, 520 can be opened and used oil can be pumped via the fryer/filter pump 510, through a filter station 502 (FIG. 5) or a bypass around the filter station and into the piloted solenoid valve assembly 100. Based on an operator determination that the used oil pumped from the fryer station 512 is beyond appropriate further use, the system 500 can be placed in the dispose mode 602 shown in FIG. 6. In the dispose mode 602, a valve member 202 of the piloted solenoid valve assembly 100 can be drawn into an electromagnetic coil 222 of a solenoid mechanism 104, thereby allowing the used oil to flow through the fluid line 514 leading to the waste station 504 (FIG. 5).

When it is determined by the operator that the appropriate amount of used oil is pumped to the waste station 504, the solenoid mechanism 104 can be de-energized causing the valve member to move to an outlet flow-blocking and non-bleed positions. As the pressure in the pipe line 514 leading to the waste station 504 drops, the check valve assembly 522 closes. When the piloted solenoid valve assembly 100 and the check valve assembly 522 close, it has been found that a vacuum may be created in the fluid line 514 leading to the waste station 504 (e.g., due to fluid momentum or the cooling of hot cooking oil trapped in the fluid line).

As a result, the next time it is desired to position the system 500 in the dispose mode 602, the piloted solenoid valve assembly 100 must overcome the vacuum or other pressures acting over a surface area of the valve first end 208. Advantageously, a pilot 204 covers portions of the surface area of the valve first end 208 which the vacuum or other pressures would otherwise act on. In this way, a solenoid mechanism force needed to overcome the vacuum or other pressures is reduced. Without the use of the pilot 204, the oil handling system 500 may become inoperable to valve lock-up. Experimental results demonstrate that the present piloted solenoid valve assembly 100 can overcome vacuum or other pressures acting on the valve member 202 multiple times greater than conventional solenoid valve assemblies. For instance, a conventional solenoid valve assembly was found to overcome fluid line vacuum pressures of 12-15 psi, while the present piloted solenoid valve assembly 100 was found to overcome vacuum pressures in excess of 60 psi under otherwise similar system conditions.

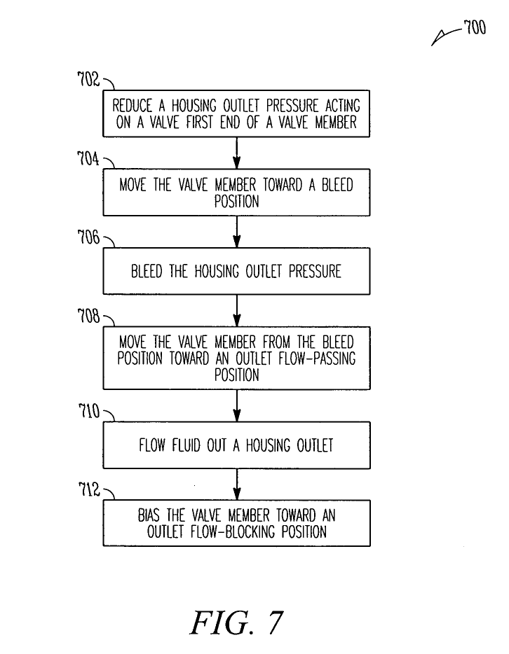

FIG. 7 is a block diagram of an example method 700 of using a piloted solenoid valve assembly in a fluid handling system. At 702, a housing outlet pressure acting on a first end of a valve member is reduced by covering a portion of the valve first end. In various examples, covering the portion of the valve first end with the pilot includes reducing a surface area of the valve first end subject to the housing outlet pressure when the valve member is in an outlet flow-blocking and non-bleed positions. At 704, with the housing outlet pressure acting on the valve member reduced, the valve member is moved toward a bleed position in opposition to a spring bias. In an example, moving the valve member toward the bleed position includes moving the valve member relative to the pilot, such as moving the valve first end within a pilot bore to a position spaced from a pilot outlet. To cause movement of the valve member from the outlet flow-blocking position, a solenoid mechanism force greater in magnitude than the reduced housing outlet pressure and spring bias is generated and used at 704. At 706, the housing outlet pressure is bled by allowing fluid flow into and through the pilot.

At 708, the valve member is moved from the bleed position toward an outlet flow-passing position. When the valve member is in the outlet flow-passing position, fluid is allowed to flow into a housing inlet and out a housing outlet, at 710. When a determination is made that enough fluid has flowed into the housing outlet, the valve member can be moved toward the outlet flow-blocking and non-bleed positions, at 712. In an example, when the valve member is positioned in the outlet flow-blocking and non-bleed positions, fluid flows out a housing by-pass.

Conclusion:

Valve assemblies for fluid handling systems are provided. The valve assemblies include a valve member having a first end movable between an outlet flow-passing and an outlet flow-blocking position. The valve assemblies include a solenoid mechanism operatively associated with a valve member second end to move the valve member toward one of the outlet flow-blocking or flow-passing positions. Advantageously, the present valve assemblies further include a pilot configured to cover a portion of the valve member first end subject to housing outlet pressures such that a solenoid mechanism force needed to move the valve member from the outlet flow-blocking position is reduced. In this way, the pilot allows the valve assemblies to overcome greater vacuum and other housing outlet pressures opposing valve member movement from the outlet flow-blocking position than what is possible using a conventional solenoid valve assembly; thus, maintain a fluid handling system in an operable state.

Closing Notes:

The above Detailed Description includes references to the accompanying drawings, which form a part of the Detailed Description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more features thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. In addition, while the majority of this patent document discusses using the present valve assemblies and methods in a cooking oil supply, filter, and disposal system, the present valve assemblies and methods can also be used in other fluid handling systems where it is desired to provide flow control along one or more flow paths. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

What is claimed is:

1. A valve assembly comprising:
a valve member extending from a valve first end to a valve second end, the valve member movable between an outlet flow-blocking and an outlet flow-passing position;
a solenoid mechanism operatively associated with the valve second end to move the valve member from the outlet flow-blocking to the outlet flow-passing position; and
a pilot covering a portion of the valve first end, the pilot reducing a solenoid mechanism force needed to move the valve member from the outlet flow-blocking position.

2. The valve assembly of claim 1, comprising a resilient member configured to bias the valve member in opposition to a movement caused by the solenoid mechanism.

3. The valve assembly of claim 1, comprising a housing having at least one housing inlet, at least one housing outlet, and a housing bore therebetween, the housing bore including at least the valve first end disposed therein.

4. The valve assembly of claim 3, wherein the housing includes a housing by-pass, the housing bore in fluid communication with the housing by-pass.

5. The valve assembly of claim 3, wherein the housing includes a pilot seat surrounding the housing outlet, a portion of the pilot contacting the pilot seat at least when the valve member is in the outlet flow-blocking position.

6. The valve assembly of claim 1, wherein the pilot includes a pilot inlet, a pilot outlet, and a pilot bore therebetween, the valve first end disposed in the pilot bore such that a portion thereof faces the pilot outlet.

7. The valve assembly of claim 6, wherein the valve first end is movable within the pilot bore between a bleed and a non-bleed position, the non-bleed position defined by the valve first end contacting a valve member seat surrounding the pilot outlet.

8. The valve assembly of claim 7, wherein the valve first end is spaced from the valve member seat in the bleed position.

9. The valve assembly of claim 7, wherein the pilot reduces a surface area of the valve first end subject to a pressure extending through the housing outlet when the valve first end is in the non-bleed position.

10. A valve assembly comprising:
a housing including a housing inlet, a housing outlet, and a housing bore, the housing bore connecting at least the housing inlet and housing outlet;
a valve member including a head region disposed within the housing bore, the valve member movable between an outlet flow-blocking and an outlet flow-passing position;
a solenoid mechanism operatively associated with the valve member to move the valve member from the outlet flow-blocking to the outlet flow-passing position; and
a pilot covering at least a portion of the head region such that a reduced surface area of the head region is in communication with a pressure extending through the housing outlet when the valve member is in the outlet flow-blocking position.

11. The valve assembly of claim 10, comprising a resilient member configured to bias the valve member in opposition to a movement caused by the solenoid mechanism.

12. The valve assembly of claim 10, wherein the pilot includes a pilot inlet, a pilot outlet, and a pilot bore therein, the head region disposed in the pilot bore such that the reduced surface area aligns with the pilot outlet.

13. The valve assembly of claim 12, wherein the head region is movable between a non-bleed position in which a perimeter of the reduced surface area contacts a valve member seat surrounding the pilot outlet and a bleed position in which the perimeter of the reduced surface area is spaced from the valve member seat.

14. The valve assembly of claim 13, wherein the head region of the valve member is movable relative to the pilot between the non-bleed and bleed positions.

15. A method comprising:
reducing a housing outlet pressure acting on a valve first end of a valve member, including coving a portion of the valve first end with a pilot;
operating a solenoid mechanism to move the valve member toward a bleed position in opposition to a spring bias; and
bleeding the housing outlet pressure, including allowing fluid flow into and through the pilot.

16. The method of claim 15, comprising operating the solenoid mechanism to move the valve member from the bleed position toward an outlet flow-passing position in further opposition to the spring bias.

17. The method of claim 16, comprising flowing fluid into a housing inlet and out a housing outlet.

18. The method of claim 15, comprising biasing the valve member to move toward an outlet flow-blocking position, including allowing fluid to flow out a housing by-pass.

19. The method of claim 15, wherein coving the portion of the valve first end with the pilot includes reducing a surface area of the valve first end subject to the housing outlet pressure when the valve member is in an outlet flow-blocking position.

20. The method of claim 15, wherein moving the valve member toward the bleed position includes moving the valve member relative to the pilot.

21. The method of claim 15, wherein moving the valve member toward the bleed position includes moving the valve member within a pilot bore to a position spaced from a pilot outlet.

22. The method of claim 15, wherein moving the valve member toward the bleed position includes generating a solenoid mechanism force greater than the reduced housing outlet pressure acting on the valve first end.
